(19) United States
(12) Patent Application Publication
(10) Pub. No.: US 2006/0262563 A1
(43) Pub. Date: Nov. 23, 2006

(54) Light guide plate and backlight module using the same

(75) Inventors: Yi Xu, Shenzhen (CN); Che-Kuei Mai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/438,831

(22) Filed: May 23, 2006

(30) Foreign Application Priority Data
May 23, 2005 (TW) 94208350

(51) Int. Cl. F21V 7/04

(52) U.S. Cl. 362/615

(57) ABSTRACT

A backlight module (30) includes a light guide plate and a light source (210). The light guide plate includes a light incident surface, and a light diffusion cavity (308) disposed corresponding to the light incident surface. The light source is disposed adjacent to the light incident surface. One of surfaces (309) of the light guide plate defining the light diffusion cavity includes a plurality of prism structures, the surface being the one nearest to the light incident surface. Most of the light from the light source can be diffused uniformly by the prism structures before entering an efficient display area of the light guide plate. This reduces or eliminates what would otherwise be one or more dark areas in the light guide plate, and results in the uniform emitting of light from the light guide plate.

### BACKGROUND

1. Field of the Invention

The present invention relates to a light guide plate (LGP) and a backlight module using the same.

2. General Background

Liquid crystal displays are commonly used as display devices for compact electronic apparatuses, because they not only provide good quality images with little power but also are very thin. The liquid crystals in a liquid crystal display do not emit any light themselves. The liquid crystals have to be lit by a light source so as to clearly and sharply display text and images. Thus, a backlight module for an LCD is generally needed.

A typical backlight module is shown in FIG. 9. The backlight module 10 includes a light guide plate 100 and a light source 110. The light guide plate 100 includes a light incident surface 102, and a light emitting surface 104 adjoining the light incident surface 102. The light emitting surface 104 includes an efficient display area 106. The light source 110 includes two light emitting diodes (LEDs) 111 disposed adjacent to the light incident surface 102. Light beams from the light source 110 enter the light guide plate 100 through the light incident surface 102, and are then emitted from the light emitting surface 104.

The light beams emit from the light source 110 over a certain range of angles of divergence, due to limitations inherent in the structure of each LED 111 itself. Therefore, insufficient incident light beams reach part of the light incident surface 102, and a dark area 108 appears in the efficient display area 106 near the light incident surface 102. This results in a non-uniform display of the associated LCD.

What is needed, therefore, is a backlight module and a light guide plate used therein which can provide uniform light.

### SUMMARY

In one preferred embodiment, a light guide plate includes a light incident surface, and a light diffusion cavity disposed corresponding to the light incident surface. One of inner surfaces of the light guide plate bounding the light diffusion cavity includes a plurality of prism structures, the surface being the one nearest to the light incident surface.

In another preferred embodiment, a light guide plate includes a light incident surface, and a light diffusion cavity disposed corresponding to the light incident surface. One of inner surfaces of the light guide plate bounding the light diffusion cavity includes a diffusing pattern, the surface being the one furthest from the light incident surface.

In a further preferred embodiment, a backlight module includes a light guide plate and a light source. The light guide plate includes a light incident surface, and a light diffusion cavity disposed corresponding to the light incident surface. The light source is disposed adjacent to the light incident surface. One of inner surfaces of the light guide plate bounding the light diffusion cavity includes-a plurality of prism structures, the surface being the one nearest to the light incident surface. Most of the light from the light source can be diffused uniformly by the prism structures before entering an efficient display area of the light guide plate. This reduces or eliminates what would otherwise be one or more dark areas in the light guide plate, and results in the uniform emitting of light from the light incident surface of the light guide plate.

In a still further preferred embodiment, a backlight module includes a light guide plate and a light source. The light guide plate includes a light incident surface, and a light diffusion cavity disposed corresponding to the light incident surface. The light source is disposed adjacent to the light incident surface. One of inner surfaces of the light guide plate bounding the cavity includes a light diffusing pattern, the surface being the one furthest from the light incident surface. The backlight module has advantages similar to those of the backlight module of the above-described further preferred embodiment.

Other advantages and novel features will become more apparent from the following detailed description of these and other preferred embodiments when taken in conjunction with the accompanying drawings, in which:

### BRIEF DESCRIPTION OF THE DRAWINGS

FIG. 1 is a schematic, top plan view of a light guide plate having a light diffusion cavity according to a first preferred embodiment of the present invention;

FIG. 2 is a schematic, enlarged view of a circled portion II of FIG. 1;

FIG. 3 is a schematic, enlarged, top plan view of part of a light guide plate having a light diffusion cavity, according to a second preferred embodiment of the present invention;

FIG. 4 is a schematic, top plan view of a light guide plate according to a third preferred embodiment of the present invention;

FIG. 5 is a schematic, top plan view of a light guide plate according to a fourth preferred embodiment of the present invention;

FIG. 6 is a schematic, top plan view of a light guide plate according to a fifth preferred embodiment of the present invention;

FIG. 7 is a schematic, top plan view of a backlight module according to another preferred embodiment of the present invention, showing essential optical paths thereof;

FIG. 8 is a schematic, top plan view of a backlight module according to still another preferred embodiment of the present invention, showing essential optical paths thereof; and

FIG. 9 is a schematic, top plan view of a conventional backlight module, showing essential optical paths thereof.

### DETAILED DESCRIPTION OF PREFERRED EMBODIMENTS

Reference will now be made to the drawings to describe the preferred embodiments in detail.

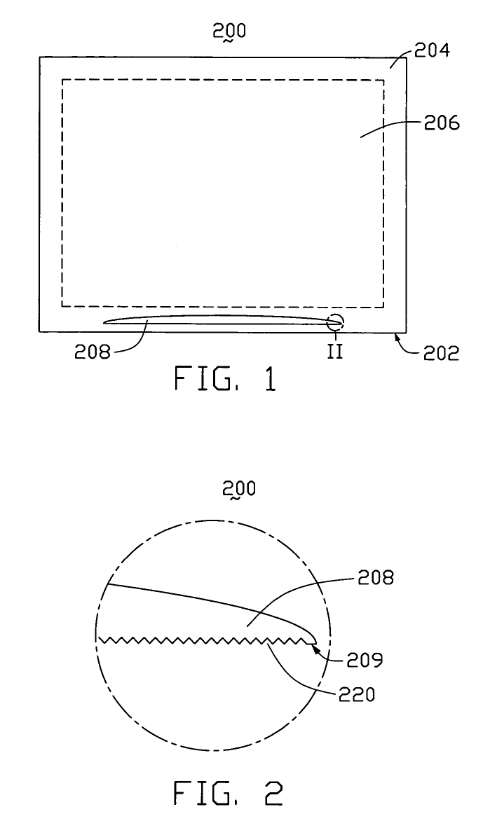

Referring to FIG. 1 and FIG. 2, a light guide plate 200 according to a first preferred embodiment of the present invention includes a light incident surface 202, and a light emitting surface 204 adjoining the light incident surface 202. The light emitting surface 204 includes an efficient display area 206. The light guide plate 200 further includes an elongate light diffusion cavity 208 disposed between the light incident surface 202 and the efficient display area 206. The light diffusion cavity 208 is open to both of top and bottom sides of the light guide plate 200. An inner surface 209 of the light guide plate 200 bounds a part of the light diffusion cavity 208 nearest to the light incident surface 202. The inner surface 209 includes a plurality of continuous prism structures 220. The prism structures 220 define a plurality of V-shaped grooves. The light guide plate 200 can be made from polymethyl methacrylate (PMMA) or polycarbonate (PC).

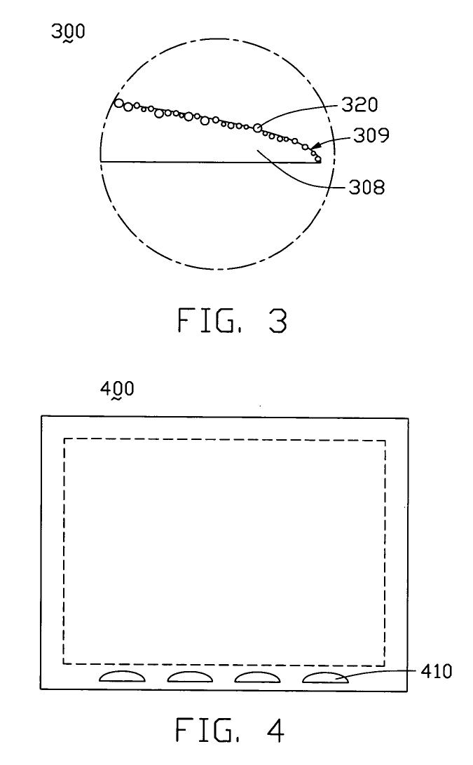

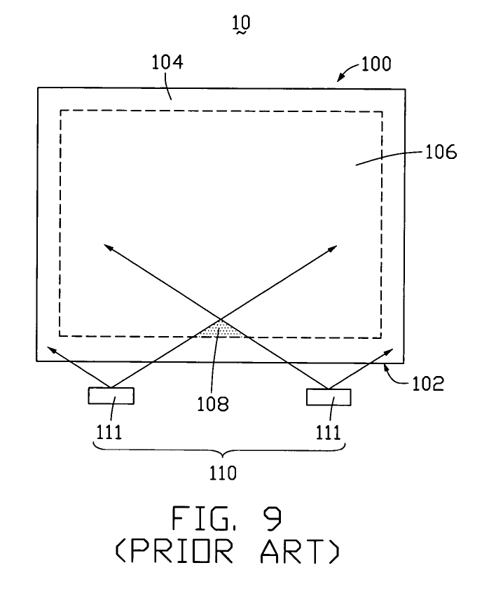

FIG. 3 is a schematic, enlarged, top plan view of part of a light guide plate 300 having a light diffusion cavity 308, according to a second embodiment of the present invention. The full light guide plate 300 is shown in FIG. 8. The light guide plate 300 is similar to the light guide plate 200 of the first embodiment. However, an inner surface 309 of the light guide plate 300 bounds a part of the light diffusion cavity 308 furthest from a light incident surface 302 of the light guide plate 300. The surface 309 includes a diffusing pattern. The diffusing pattern includes a multiplicity of diffusing particles 320. The diffusing particles 320 can be made from polymethyl methacrylate (PMMA) or polycarbonate (PC).

FIG. 4 is a schematic, top plan view of a light guide plate 400 according to a third embodiment of the present invention. The light guide plate 400 is similar to the light guide plate 200 of the first embodiment. However, the light guide plate 400 includes a plurality of separate micro light diffusion cavities 410 linearly arranged therein. Inner surfaces (not labeled) of the light guide plate 400 that bound the light diffusion cavities 410 are all smooth.

FIG. 5 is a schematic, top plan view of a light guide plate 500 according to a fourth embodiment of the present invention. The light guide plate 500 is similar to the light guide plate 400 of the third embodiment. However, the light guide plate 500 includes a plurality of separate micro light diffusion cavities 510 arranged in a matrix. In the illustrated embodiment, the matrix comprises two rows of micro light diffusion cavities 510, with the micro light diffusion cavities 510 of one row being medially offset from the micro light diffusion cavities 510 of the other row.

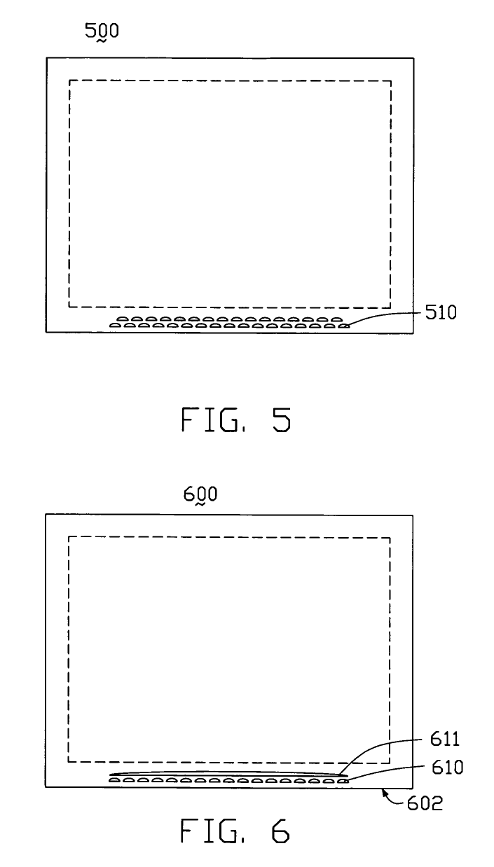

FIG. 6 is a schematic, top plan view of a light guide plate 600 according to a fifth embodiment of the present invention. The light guide plate 600 is similar to the light guide plate 200 of the first embodiment. However, the light guide plate 600 includes an elongate light diffusion cavity 611, and a plurality of micro light diffusion cavities 610 linearly arranged to be parallel to the light diffusion cavity 611. The micro light diffusion cavities 610 are disposed between the light diffusion cavity 611 and a light incident surface 602 of the light guide plate 600, and cooperate with the light diffusion cavity 611 to diffuse light beams.

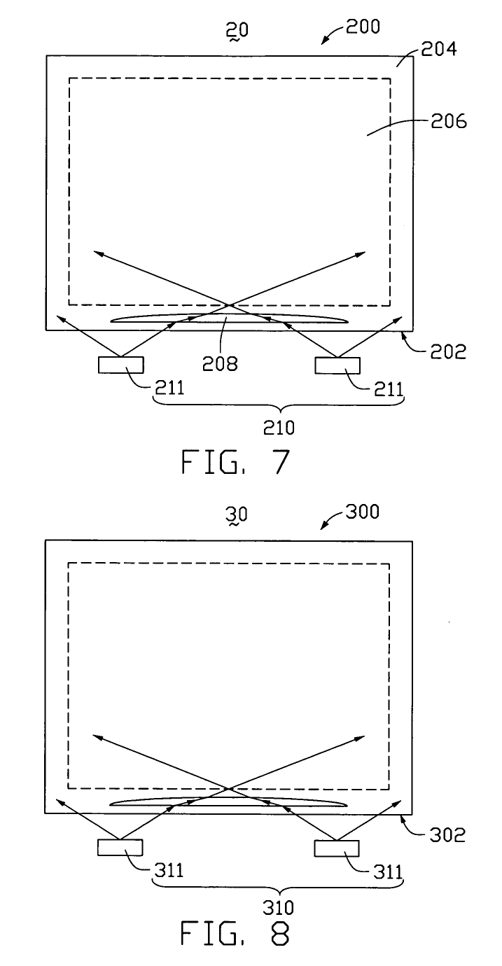

FIG. 7 is a schematic, top plan view of a backlight module 20 according to the present invention. The backlight module 20 includes the light guide plate 200 of the first embodiment and a light source 210. The light source 210 includes two LEDs 211 positioned adjacent to the light incident surface 202.

Referring also to FIGS. 1-2, in operation, light beams from the light source 210 enter the light guide plate 200 through the light incident surface 202. Some of the light beams travel to the efficient display area 206 directly. Other light beams enter the light diffusion cavity 208, are refracted by the prism structures 220 of the inner surface 209, are diffused by particles (not shown) in the air of the light diffusion cavity 208, and then finally travel to the efficient display area 206. Thus the divergence angles of the light beams entering the efficient display area 206 are broadened, and the light beams entering the efficient display area 206 are uniformly diffused.

FIG. 8 is a schematic, top plan view of another backlight module 30 according to the present invention. The backlight module 30 includes the light guide plate 300 of the second embodiment and a light source 310. The light source 310 includes two LEDs 311 positioned adjacent to a light incident surface 302 of the light guide plate 300.

As regards the light guide plate 200 of the first embodiment, the prism structures 220 of the light guide plate 200 ensure that most of the incident light beams from the associated light source 210 can be diffused uniformly before entering the efficient display area 206 of the light guide plate 200. This reduces or eliminates what would otherwise be one or more dark areas in the light guide plate 200, and results in the uniform emitting of light from the light emitting surface 204 of the light guide plate 200. As regards the light guide plate 300 of the second embodiment, similar advantages are obtained by reason of the diffusing particles pattern 320 of the diffusing pattern thereof.

In alternative embodiments of the light guide plate 200, the prism structures 220 can be configured to be discontinuous according to need. In alternative embodiments of any of the light guide plates 200, 300, 400, 500, 600, any one or more features of any one of the light guide plates 200-600 can be combined with any one or more other features of any one of the other light guide plates 200-600. In further alternative embodiments of either of the backlight modules 20, 30, the backlight module 20, 30 can further include a reflective film and/or a polarizer. Further, the light diffusion cavity 208, 308 of the backlight module 20, 30 can be closed. That is, the light diffusion cavity 208, 308 is not open to both of top and bottom sides of the light guide plate 200, 300.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light guide plate, comprising:
a light incident surface; and
a light diffusion cavity structure disposed corresponding to the light incident surface,
wherein a surface of the light guide plate defining part of the light diffusion cavity structure nearest to the light incident surface comprises a plurality of prism structures.

2. The light guide plate as claimed in claim 1, wherein the prism structures define a plurality of V-shaped grooves.

3. The light guide plate as claimed in claim 1, wherein the light diffusion cavity structure comprises a single light diffusion cavity.

4. The light guide plate as claimed in claim 1, wherein the light diffusion cavity structure comprises a plurality of separate micro light diffusion cavities.

5. The light guide plate as claimed in claim 4, wherein the micro light diffusion cavities are linearly arranged.

6. The light guide plate as claimed in claim 4, wherein the micro light diffusion cavities are arranged in a matrix.

7. The light guide plate as claimed in claim 3, wherein the light diffusion cavity structure further comprises a plurality of separate micro light diffusion cavities.

8. The light guide plate as claimed in claim 7, wherein the micro light diffusion cavities cooperate with the light diffusion cavity to scatter incident light.

9. The light guide plate as claimed in claim 1, wherein the light guide plate is made from polymethyl methacrylate.

10. The light guide plate as claimed in claim 1, wherein the light guide plate is made from polycarbonate.

11. A light guide plate, comprising:
a light incident surface; and
a light diffusion cavity structure disposed corresponding to the light incident surface;
wherein a surface of the light guide plate defining part of the light diffusion cavity structure furthest away from the light source comprises a diffusing pattern.

12. The light guide plate as claimed in claim 11, wherein the light diffusion cavity structure comprises a single light diffusion cavity.

13. The light guide plate as claimed in claim 11, wherein the light diffusion cavity structure comprises a plurality of separate micro light diffusion cavities.

14. The light guide plate as claimed in claim 13, wherein the micro light diffusion cavities are linearly arranged.

15. The light guide plate as claimed in claim 13, wherein the micro light diffusion cavities are arranged in a matrix.

16. The light guide plate as claimed in claim 12, wherein the light diffusion cavity structure further comprises a plurality of separate micro light diffusion cavities.

17. The light guide plate as claimed in claim 16, wherein the micro light diffusion cavities cooperate with the light diffusion cavity to scatter incident light.

18. The light guide plate as claimed in claim 1, wherein the light guide plate is made from polymethyl methacrylate or polycarbonate.

19. A backlight module comprising:
a light source; and
a light guide plate disposed corresponding to the light source, comprising:
a light incident surface; and
a light diffusion cavity structure disposed corresponding to the light incident surface,
wherein a surface of the light guide plate defining part of the light diffusion cavity structure nearest to the light incident surface comprises a plurality of prism structures.

20. The backlight module as claimed in claim 19, wherein the light source comprises at least one light emitting diode.
